(19) United States
(12) Patent Application Publication
(10) Pub. No.: US 2026/0092794 A1
(43) Pub. Date: Apr. 2, 2026

(54) DETECTION MECHANISM AND IMAGE PICKUP APPARATUS HAVING THE SAME

(71) Applicant: CANON KABUSHIKI KAISHA, Tokyo (JP)

(72) Inventor: YOHEI YAMADA, Tokyo (JP)

(21) Appl. No.: 19/331,432

(22) Filed: Sep. 17, 2025

(30) Foreign Application Priority Data
Oct. 2, 2024 (JP) 2024-173110

(51) Int. Cl. G01D 5/347; G03B 7/08

(52) U.S. Cl. CPC G01D 5/3473; G03B 7/08

(57) ABSTRACT

A detection mechanism includes a rotational operation member rotatable around a rotation axis, a phase plate that includes reflective portions disposed on concentric circles around the rotation axis, and a non-reflective portion, and is rotatable together with the rotational operation member, detection elements arranged on the concentric circles facing either one of the reflective portions or the non-reflective portion, and configured to output a signal according to an intensity of light reflected by either one of the reflective portions or the non-reflective portion, and one or more processors that, upon execution of the instructions, operate to determine a rotation position of the rotational operation member according to an output of each of the plurality of detection elements. The detection elements are arranged on different straight lines that pass through the rotation axis and extend in a radial direction perpendicular to the rotation axis.

### BACKGROUND

### Field of the Technology

The aspect of the disclosure relates to one or more embodiments of a detection mechanism configured to detect a rotation position of a rotational operation member (rotatable member).

### Description of the Related Art

Some conventional electronic apparatuses, such as image pickup apparatuses, include a detection mechanism configured to detect an absolute rotational position of a rotational operation member for performing a variety of settings. Japanese Patent Application Laid-Open No. 2019-101096 discloses a structure in which a plurality of contact portions contact signal patterns arranged in plurality of concentric circles around a rotation center of the rotational operation member according to the rotation of the rotational operation member, and thereby output a binary code.

However, this structure disclosed in Japanese Patent Application Laid-Open No. 2019-101096 may generate conductive wear powder because the contact parts are brought into contact with the signal patterns. In this case, the conductive wear powder may cause short-circuiting in the signal pattern, reduce the contact reliability between the contact parts and the signal patterns, and result in erroneous detection.

### SUMMARY

One or more embodiments of a detection mechanism according to one or more aspects of the disclosure may include a rotational operation member rotatable around a rotation axis, a phase plate that includes a plurality of reflective portions disposed on a plurality of concentric circles around the rotation axis and configured to reflect light, and a non-reflective portion configured to reflect less light than each of the plurality of reflective portions, and is rotatable together with the rotational operation member, a plurality of detection elements arranged on the plurality of concentric circles facing either one of the plurality of reflective portions or the non-reflective portion, and configured to output a signal according to an intensity of light reflected by either one of the plurality of reflective portions or the non-reflective portion, one or more memories storing instructions, and one or more processors that, upon execution of the instructions, operate to determine a rotation position of the rotational operation member according to an output of each of the plurality of detection elements. The plurality of detection elements are arranged on different straight lines that pass through the rotation axis and extend in a radial direction perpendicular to the rotation axis. One or more image pickup apparatuses may include one or more detection mechanisms in accordance with one or more other aspects of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram of a camera according to a first embodiment.

FIGS. 2A and 2B are external perspective views of the camera according to the first embodiment.

FIG. 3 is an exploded perspective view of the camera according to the first embodiment.

FIG. 4 is a perspective view illustrating the internal structure of a top cover unit according to the first embodiment.

FIGS. 5A and 5B are exploded perspective views of the top cover unit according to the first embodiment.

FIG. 6 is a sectional view of the top cover unit according to the first embodiment at the center of a rotation axis of a dial.

FIG. 7 illustrates a positional relationship between a phase plate and a detection element according to the first embodiment.

FIG. 8 illustrates a signal output when a phase of the dial according to the first embodiment is located at each of twelve positions.

FIGS. 9A and 9B illustrate a positional relationship between the phase plate and the detection element according to the first embodiment.

FIG. 10 illustrates a positional relationship between a phase plate and a detection element according to a second embodiment.

FIG. 11 illustrates a signal output when a phase of the dial of the second embodiment is located at each of eight positions.

FIGS. 12A and 12B explain a click mechanism and a phase plate according to a third embodiment.

FIGS. 13A and 13B explain a phase plate according to a fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### FIRST EMBODIMENT

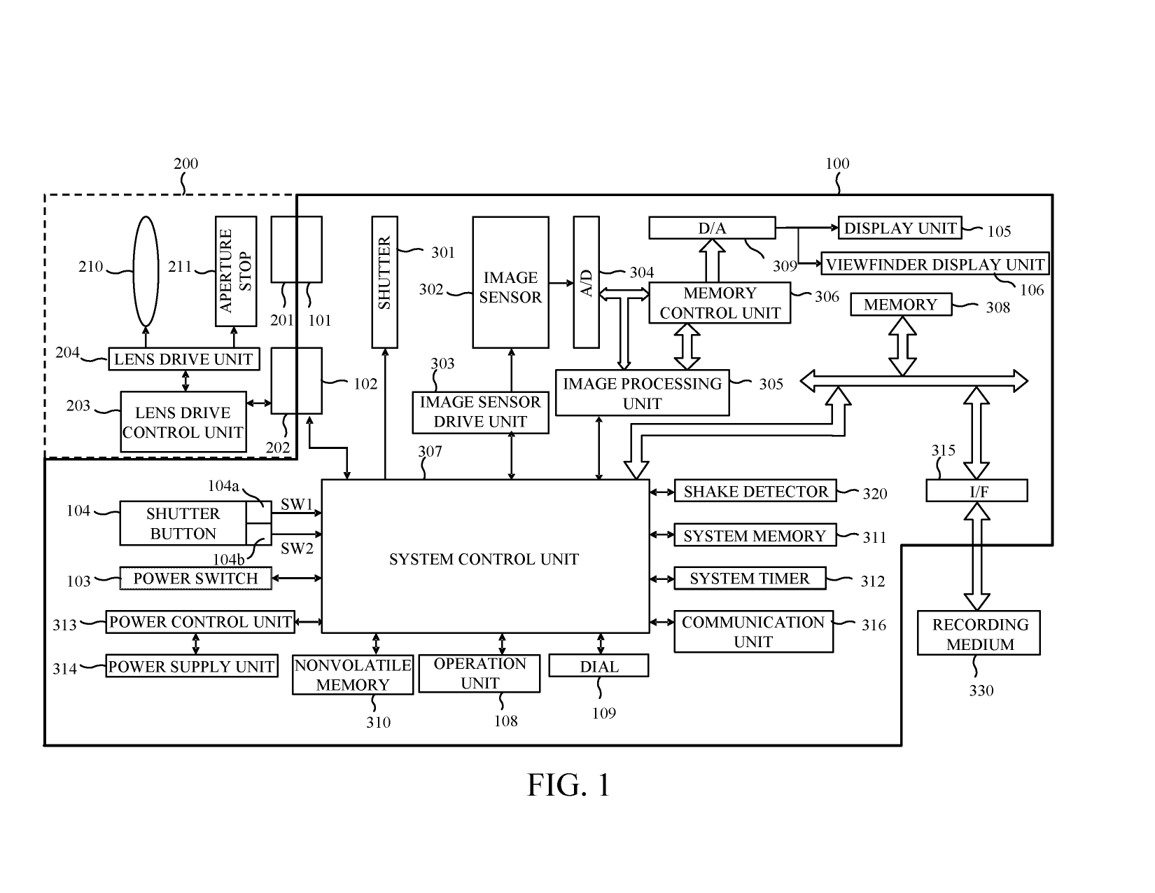

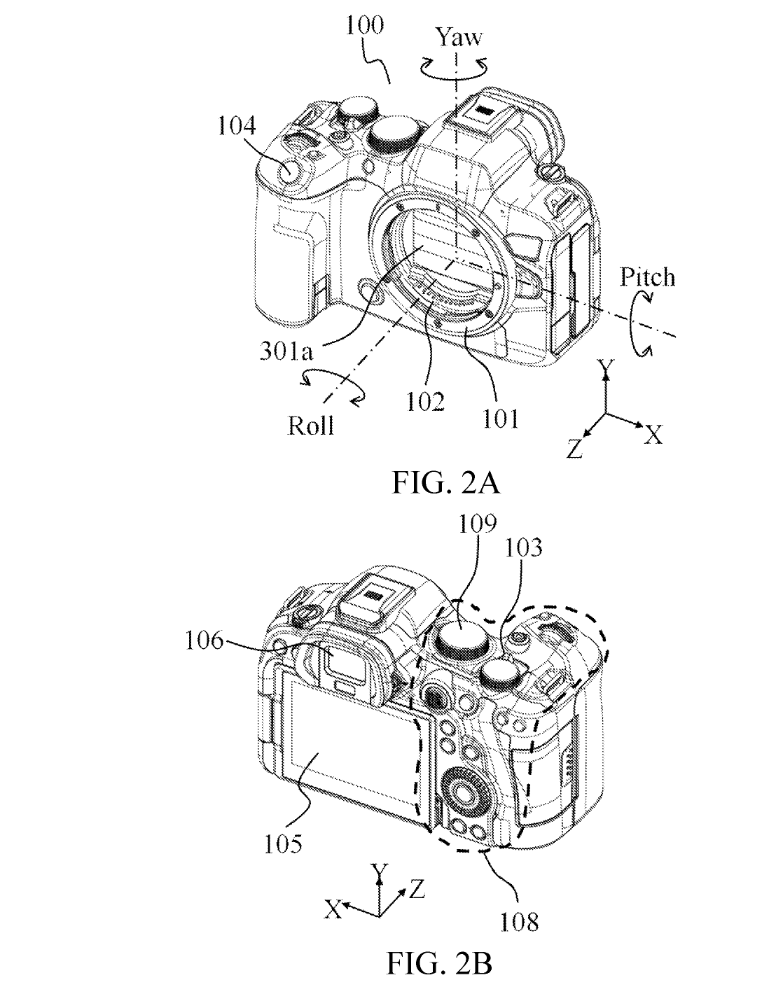

FIG. 1 is a block diagram of a camera (image pickup apparatus) 100 according to this embodiment. FIGS. 2A and 2B are external perspective views of the camera 100. FIGS. 2A and 2B are views of the camera 100 as viewed from the front and rear, respectively.

The camera 100 is a lens interchangeable type camera to which a lens unit 200 can be detachably attached. The lens unit 200 is fixed to the camera 100 by a lens mount 201 provided on the lens unit 200 and a camera mount 101 provided on the camera 100. The lens unit 200 and the camera 100 can communicate with each other via a lens-side connector 202 provided on the lens unit 200 and a camera-side connector 102 provided on the camera 100. More specifically, a system control unit (determining unit) 307 and a lens drive control unit 203 communicate with each other, and the lens drive control unit 203 controls a lens drive unit 204 based on a signal from the system control unit 307, and the lens drive unit 204 drives an aperture stop 211 and a lens 210. The lens 210 guides light from an object to an image sensor 302.

A shutter 301 is a focal plane shutter and is placed between the image sensor 302 and the lens 210. In a non-imaging state, it shields light from the lens 210 to the image sensor 302. During imaging or through-image display (live-view display), shutter blades 301a open under the control of the system control unit 307, allowing light from the lens 210 to be guided to the image sensor 302. The image sensor 302 includes CCD or CMOS elements configured to convert an optical image into an electrical signal, and has an electronic shutter function.

An A/D converter 304 converts an analog signal output from the image sensor 302 into a digital signal.

An image processing unit 305 performs resizing processing such as predetermined pixel interpolation and reduction, and color conversion processing for the data from the A/D converter 304 or the data from a memory control unit 306. The image processing unit 305 performs predetermined calculation processing using captured image data, and the system control unit 307 performs exposure control and focus detection control based on the obtained calculation result. Thereby, through-the-lens (TTL) type autofocus (AF) processing, auto-exposure (AE) processing, pre-flash (EF) processing, and auto white balance (AWB) processing are performed.

The output data from the A/D converter 304 is written to a memory 308 via the image processing unit 305 and the memory control unit 306, or directly via the memory control unit 306. The memory 308 stores image data converted into digital data by the A/D converter 304 for display on a display unit 105 or a viewfinder display unit 106. The memory 308 also serves as a memory for image display (video memory). A D/A converter 309 converts the image display data stored in the memory 308 into an analog signal and supplies it to the display unit 105 or the viewfinder display unit 106. Thus, the image data for display written in the memory 308 is displayed by the display unit 105 or the viewfinder display unit 106 via the D/A converter 309. The display unit 105 and the viewfinder display unit 106 display on a display such as an LCD according to an analog signal from the D/A converter 309. The display unit 105 also has a built-in electrostatic capacitance or pressure-sensitive touch panel, and has a touch panel function that allows the user to perform a variety of operations by touching it with a finger or the like. The digital signal that is once A/D converted by the A/D converter 304 and stored in the memory 308 is converted to analog in the D/A converter 309, and is sequentially transferred to and displayed on the display unit 105 or the viewfinder display unit 106, thereby enabling a through image display.

A nonvolatile memory 310 is an electrically erasable and recordable recording medium, and can use, for example, an EEPROM. The nonvolatile memory 310 stores constants and programs for operations of the system control unit 307.

The system control unit 307 is a control unit that has at least one processor, and controls the entire camera 100 and the lens unit 200. A RAM is used for a system memory 311. Constants and variables for the operation of the system control unit 307, and programs read from the nonvolatile memory 310 are loaded into the system memory 311. The system control unit 307 also performs display control by controlling the memory 308, D/A converter 309, display unit 105, and viewfinder display unit 106.

A system timer 312 measures the time for a variety of controls and the time of a built-in clock.

A first shutter switch 104a is turned on by half-pressing a shutter button 104 provided on the camera 100 (imaging preparation instruction) during operation, and generates a first shutter switch signal SW1. The first shutter switch signal SW1 starts operations such as AF processing, AE processing, AWB processing, and EF processing.

A second shutter switch 104b is turned on when the shutter button 104 is fully pressed (imaging instruction) and generates a second shutter switch signal SW2. The system control unit 307 controls the shutter blades 301a to be driven by the second shutter switch signal SW2, and starts a series of imaging processing operations from reading the signal from the image sensor 302 to writing image data to a recording medium 330. The shutter blades 301a run at high speed inside the shutter 301 in a direction perpendicular to the optical axis of the lens 210, and stop operating instantly when they collide with a stopper member (not illustrated) inside the shutter 301.

Each operation member of an operation unit 108 is assigned a function proper for each scene by selecting and operating a variety of function icons displayed on the display unit 105 and the viewfinder display unit 106, and acts as a variety of function buttons. The function buttons include, for example, an end button, a back button, an image forward button, a jump button, a narrowing-down button, and an attribute change button. For example, when the menu button is pressed, a variety of settable menu screens are displayed on the display unit 105 or the viewfinder display unit 106.

A dial (rotational operation member) 109 is configured to lock and produce a clicking sense at predetermined angular intervals in a circumferential direction, and the imaging mode of the camera 100 can be switched according to a locked phase (rotational position, angular phase).

The power supply to the camera 100 is turned on and off by a power switch 103.

A power control unit 313 includes a battery detection circuit, a DC-DC converter, a switch circuit that switches the blocks to which electricity is applied, etc., and detects whether a battery is installed, a battery type, and a remaining battery amount. The power control unit 313 also controls the DC-DC converter based on the detection result and instruction from the system control unit 307, and supplies the required voltage for the required period to each unit including the recording medium 330.

A power supply unit 314 includes a primary battery such as an alkaline battery and a lithium battery, a secondary battery such as a NiCd battery, a NiMH battery, and a Li battery, an AC adapter, etc. A recording medium I/F 315 is an interface with the recording medium 330 such as a memory card or a hard disk drive. The recording medium 330 is a recording medium such as a memory card for recording a captured image, and includes a semiconductor memory, an optical disc, a magnetic disk, or the like.

A communication unit 316 is connected wirelessly or by a wired cable, and transmits and receives image (video) signals, audio signals, and the like. The communication unit 316 can also be connected to a wireless Local Area Network (LAN) or the Internet. The communication unit 316 can transmit images (including through-images) captured by the image sensor 302 and images recorded in the recording medium 330, and can also receive image data and various other information from external devices.

A shake detector 320 includes, for example, a gyro sensor, and detects the shake amount of the camera 100. The shake detector 320 detects the shake and the shake amount in three axial directions of a pitch direction, a yaw direction, and a roll direction of the camera 100.

An image-sensor drive unit 303 performs optical shake correction by controlling the movement of the image sensor 302 in accordance with the shake amount detected by the shake detector 320. The image processing unit 305 performs electronic image stabilization for an image in accordance with the shake amount detected by the shake detector 320 under the control of the system control unit 307.

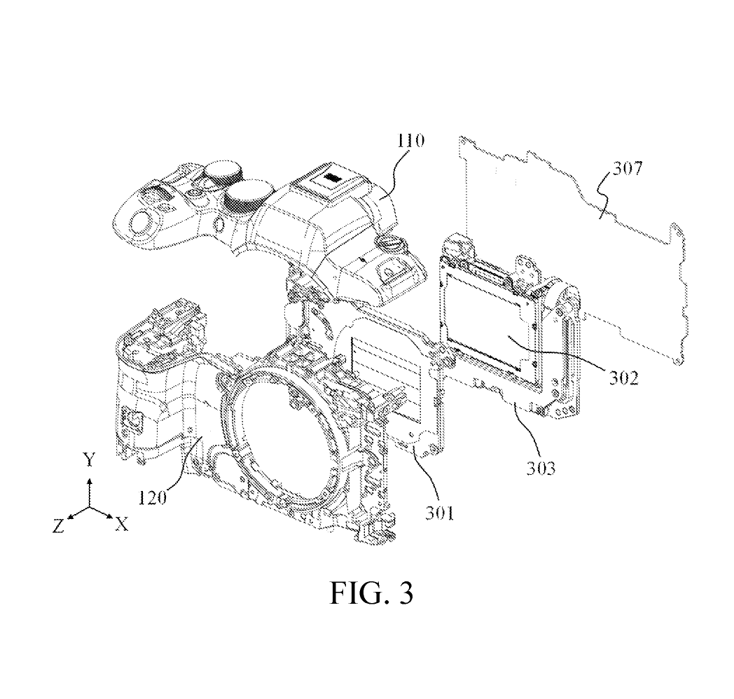

FIG. 3 is an exploded oblique view of the camera 100 with the front, rear, and bottom cover members removed. A base plate 120 has a structure that provides the strength of the camera 100, and the shutter 301, image sensor 302, image-sensor driving unit 303, and system control unit 307 are fastened with screws (not illustrated). A top cover unit 110 is fastened to the base plate 120 with screws (not illustrated).

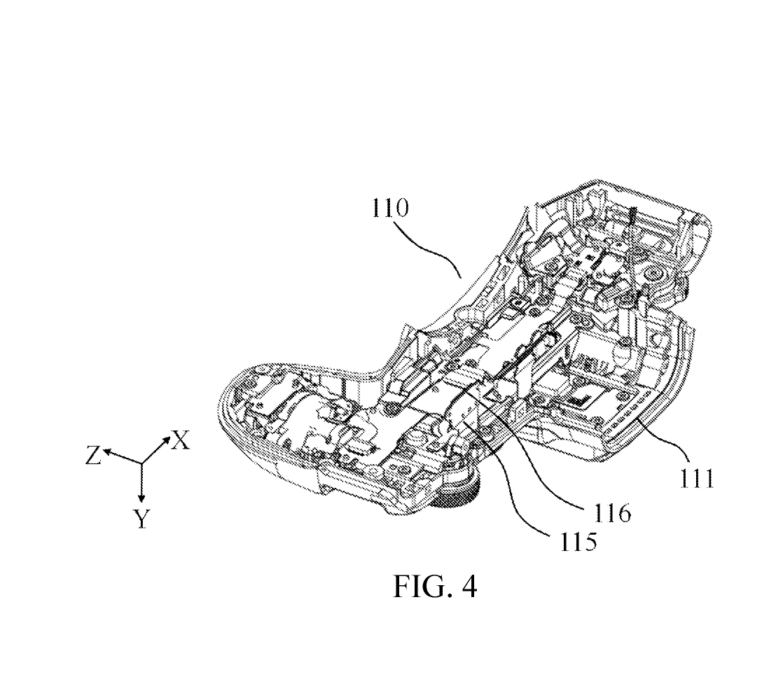

FIG. 4 is a perspective view illustrating the internal structure of the top cover unit 110. The top cover unit 110 is configured by assembling the power switch 103, shutter button 104, dial 109, etc. with screws (not illustrated) to a top cover member 111 as a housing that covers the top surface of the camera 100. A top cover unit board 115 has an electric circuit for communicating a variety of electric signals of the power switch 103, shutter button 104, dial 109, etc. with the system control unit 307, and is electrically connected to the system control unit 307 by a connector 116.

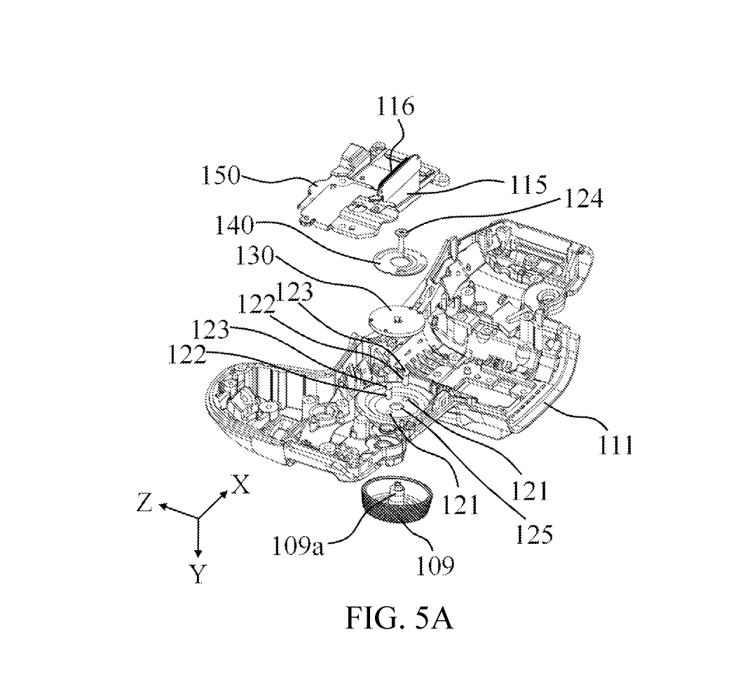

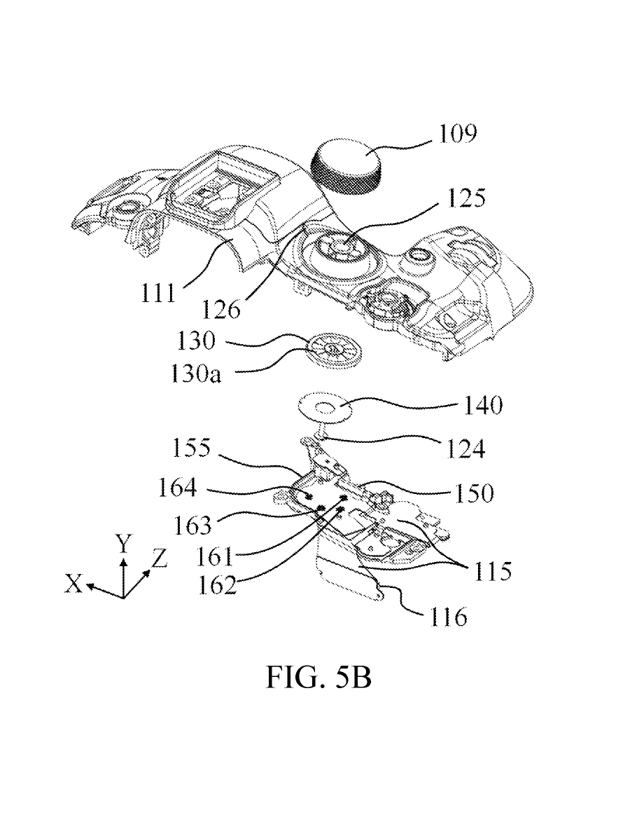

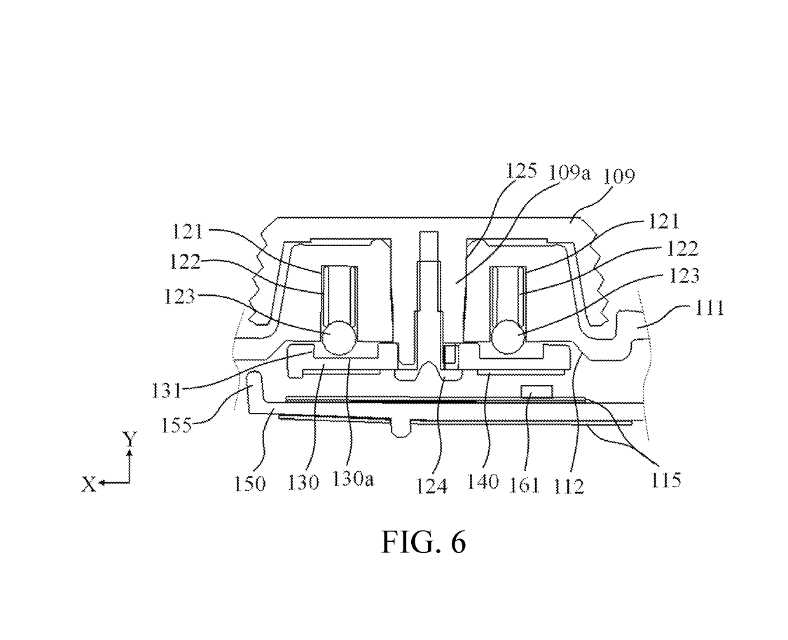

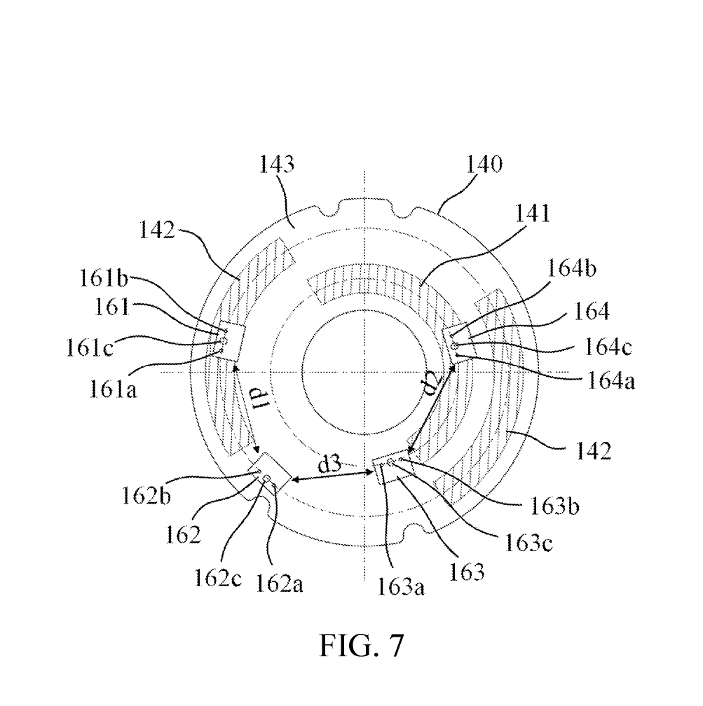

The structure of the dial 109 and a detection mechanism for detecting a phase of the dial 109 will be described below. FIGS. 5A and 5B are exploded perspective views illustrating the internal structure of the dial 109 of the top cover unit 110. FIGS. 5A and 5B are views when viewed from the inside and outside, respectively. FIG. 6 is a sectional view of the center of the rotation axis of the dial 109 of the top cover unit 110 with a variety of parts incorporated. FIG. 7 illustrates a positional relationship among a phase plate 140 and the detection elements (first detection element 161, second detection element 162, third detection element 163, and fourth detection element 164).

The dial 109 has a cylindrical shape and a shaft portion 109a as a rotation axis. The top cover member 111 includes a cylindrical insertion portion 125 for inserting the shaft portion 109a, and the dial 109 is attached rotatably around the shaft portion 109a. Coil spring-shaped click springs (biasing members) 122 made of spring wire such as piano wire, and spherical click balls (spherical members) 123 made of metal such as SUS are stored in a cylindrical storage portion 121 provided in the top cover member 111. A click member 130 is formed by injection molding of resin, and is positioned and fixed to the shaft portion 109a by a fixing screw 124, and is configured to be coaxially rotatable in conjunction with the rotation of the dial 109. The click member 130 is formed with a click groove (groove portion) 130a having a concave-convex shape at a predetermined angular interval along the circumferential direction. The click ball 123 is incorporated at a position corresponding to the concave-convex shape of the click groove 130a, and the click spring 122 is incorporated in a compressed state. Thereby, when the dial 109 is rotated, the click ball 123 falls into (is engaged with) a concave shape of the click groove 130a of the click member 130 that rotates coaxially, and a lock and clicking sense is generated at predetermined angular intervals. When the dial 109 is rotated (rotationally operated), the imaging mode of the camera 100 can be switched according to the locked phase. The exterior of the dial 109 may be marked with letters or symbols representing the imaging mode by printing or the like. An index 126 may be provided by a convex shape or printing or the like at a position corresponding to the imaging mode at that time, so that the imaging mode can be distinguished. Thereby, the user can easily distinguish the imaging mode, and this can improve convenience.

The phase plate 140 is formed of a sheet-like member made of resin or metal, and is attached to a surface of the click member 130 opposite to the click groove 130a with double-sided tape (not illustrated) or the like, and is coaxially rotatable in conjunction with the rotation of the dial 109. The phase plate 140 includes a plurality of reflective portions that reflect light and is provided in a plurality of concentric circles about on the shaft portion 109a of the dial 109 as a center, and a non-reflective portion that reflects less light than the plurality of reflective portions. In this embodiment, the plurality of reflective portions include one first reflective portion 141 provided on a concentric circle (on a first concentric circle) on the inner circumference side, and two second reflective portions 142 provided on concentric circles (on a second concentric circle) on the outer circumference side. Each of the first reflective portion 141 and the second reflective portions 142 has an annular sector shape with a predetermined central angle, and is provided in double. The first reflective portion 141 and the second reflective portions 142 are surface-treated by aluminum deposition or the like to reflect light. A non-reflective portion 143 is provided in an area other than the first reflective portion 141 and the second reflective portions 142 of the phase plate 140, and is surface-treated by black printing or the like to suppress light reflection.

A holding member 150 is formed by injection molding of resin, holds a top cover unit board 115, and is fastened to the top cover member 111 with screws (not illustrated). The top cover unit board 115 includes a first detection element 161, a second detection element 162, a third detection element 163, and a fourth detection element 164, which are arranged in order along the rotation direction of the dial 109. The third detection element 163 and the fourth detection element 164 are surface-mounted by soldering at positions that correspond to the circumference of the first reflective portion 141 and face each other at a predetermined distance. That is, the third detection element 163 and the fourth detection element 164 are arranged on a concentric circle on the inner circumference side while facing either the first reflective portion 141 or the non-reflective portion. The third detection element 163 and the fourth detection element 164 output a signal according to the intensity of light reflected by either the first reflective portion 141 or the non-reflective portion 143. The first detection element 161 and the second detection element 162 are surface-mounted by soldering at positions corresponding to the circumference of the second reflective portion 142 and facing each other at a predetermined distance. That is, the first detection element 161 and the second detection element 162 are arranged on a concentric circle on the outer circumference side while facing either the second reflective portion 142 or the non-reflective portion. The first detection element 161 and the second detection element 162 output a signal according to the intensity of light reflected by either the second reflective portion 142 or the non-reflective portion 143. In addition, "facing" includes not only strictly facing but also substantially facing (approximately facing).

The first detection element 161, the second detection element 162, the third detection element 163, and the fourth detection element 164 are non-contact detection sensors including electronic components such as photo-reflectors. Light such as infrared light emitted from a first light emitter 161a of the first detection element 161, which includes an LED, is reflected by a detection object located in a first irradiation area 161c. Then, the intensity of the light received by a first light receiver 161b, which includes a light receiving element such as a phototransistor, is output as an electrical signal. An output value is transmitted to the system control unit 307 via the top cover unit board 115. At this time, the system control unit 307 outputs a "High = 1" signal in a case where the light intensity is higher than a predetermined threshold value, and outputs a "Low = 0" signal in a case where the light intensity is not higher than the threshold value. Each of the second detection element 162, the third detection element 163, and the fourth detection element 164 has the same structure as that of the first detection element 161. This embodiment uses an electronic component such as a photo-reflector as the detection element, but is not limited to this example as long as it is a sensor capable of measuring the reflection intensity of light.

In FIG. 7, the first detection element 161 is located at a position opposite to the second reflective portion 142 and separated from it by a predetermined distance. Light emitted from the first light emitter 161a is reflected by the second reflective portion 142 and received by the first light receiver 161b. Then, the "High=1" signal is output by the system control unit 307. The second detection element 162 is located at a position opposite to the non-reflective portion 143 and separated from it by a predetermined distance. The light emitted from a second light emitter 162a is reflected by the non-reflective portion 143, but the non-reflective portion 143 is surface-treated to suppress the light reflection, so the intensity of the light received by a second light receiver 162b is not higher than the threshold value. Then, the system control unit 307 outputs the "Low = 0" signal. The third detection element 163 is located at a position opposite to the non-reflective portion 143 and separated from it by a predetermined distance. The light emitted from a third light emitter 163a is reflected by the non-reflective portion 143, but the non-reflective portion 143 is surface-treated to suppress the light reflection, so the intensity of the light received by a third light receiver 163b is not higher than the threshold value. Then, the system control unit 307 outputs the "Low = 0" signal. The fourth detection element 164 is located at a position opposite to the first reflective portion 141 and separated from it by a predetermined distance. The light emitted from a fourth light emitter 164a is reflected by the first reflective portion 141 and received by a fourth light receiver 164b. The system control unit 307 then outputs the "High=1" signal.

As described above, the phase plate 140 rotates together with the dial 109. That is, the rotation of the dial 109 changes a positional relationship among the detection elements and the first reflective portion 141, the second reflective portion 142, and the non-reflective portion 143. The phase of the dial 109 can be detected by a combination of the outputs of the detection elements at this time.

As illustrated in FIG. 7, at least a part of the non-reflective portion 143 is provided between the first reflective portion 141 on the inner circumference side and the second reflective portion 142 on the outer circumference side in the radial direction from the rotation center toward the outer circumference side. Thereby, erroneous reflection to adjacent reflective portions and erroneous detection can be prevented.

In a case where the detection elements are close to each other, so-called crosstalk may occur, in which the light emitted from each other is erroneously detected. Therefore, the first detection element 161, the second detection element 162, the third detection element 163, and the fourth detection element 164 are separated from each other by a predetermined distance. In this embodiment, the plurality of detection elements are arranged on different straight lines that pass through the shaft portion 109a (rotation center, center of the phase plate 140) and extend in the radial direction perpendicular to the shaft portion 109a. In other words, two or more detection elements are not arranged on the same straight line among the plurality of straight lines extending in the radial direction from the rotation center. More specifically, when viewed from a direction parallel to the shaft portion 109a, the plurality of detection elements are arranged so as to overlap different ranges among a plurality of ranges (four equal ranges in this embodiment) obtained by equally dividing the phase plate 140 by the number of detection elements using the straight lines intersecting the shaft portion 109a.

An inter-element distance d1 between the first detection element 161 and the second detection element 162 on the outer circumference, an inter-element distance d2 between the third detection element 163 and the fourth detection element 164 on the inner circumference, and an inter-element distance d3 between the second detection element 162 and the third detection element 163 may be equal. Thereby, the detection elements can be arranged with good space efficiency while erroneous detection can be prevented. In particular, since space can be created on the opposite side where the detection elements are placed, the size of the camera 100 can be reduced. Here, "equal" includes not only strictly equal, but also substantially equal (approximately equal).

In the first detection element 161, the first light emitter 161a, the first light receiver 161b, and the first irradiation area 161c are located at positions offset to one side in the radial direction from the center in the short side direction of the outer shape of the first detection element 161. Each of the second detection element 162, the third detection element 163, and the fourth detection element 164 also has the same structure. The first detection element 161 on the outer circumference is disposed so that the first light emitter 161a, the first light receiver 161b, and the first irradiation area 161c are disposed on the outer side in the radial direction (opposite to the shaft portion 109a). Similarly, the second detection element 162 on the outer circumference is disposed so that the second light emitter 162a, the second light receiver 162b, and a second irradiation area 162c are disposed on the outer side in the radial direction. The third detection element 163 on the inner circumference is disposed so that the third light emitter 163a, the third light receiver 163b, and a third irradiation area 163c are disposed on the inner side in the radial direction (on the side of the shaft portion 109a). Similarly, the fourth detection element 164 on the inner circumference is disposed so that the fourth light emitter 164a, the fourth light receiver 164b, and a fourth irradiation area 164c are disposed on the inner side in the radial direction (on the side of the shaft portion 109a). That is, the light emitter (second light emitter) of the detection element on the outer circumference and the light emitter (first light emitter) of the detection element on the inner circumference are disposed so as to face outward from each other. Thereby, a distance between the detection elements can be increased, and a diameter of the dial 109 can be reduced (space-saving).

In this embodiment, the first detection element 161, the second detection element 162, the third detection element 163, and the fourth detection element 164 have the same structure, but they may have different structures. For example, the detection sensitivity may be different between the first detection element 161 and the second detection element 162 on the outer circumference side and the third detection element 163 and the fourth detection element 164 on the inner circumference side. That is, when the detection element on the outer circumference and the detection element on the inner circumference receive light of the same intensity, they may output different signals. The threshold values for outputting the "High = 1" and "Low = 0" signals may be different. In this case, the reflectance of the first reflective portion 141 on the inner circumference side and the second reflective portion 142 on the outer circumference side may be different in accordance with the detection element. Thereby, erroneous reflections at adjacent reflective portions and thus erroneous detections can be prevented.

The detailed shape of each structure will be described below with reference to FIG. 6. For a simple description, FIG. 6 omits the illustration of parts other than those necessary for the description.

The click member 130 and the phase plate 140 are pressed against the detection element side by the biasing force of the click springs 122 and the click balls 123. Thereby, even when the dial 109 is being operated, a distance between the phase plate 140 and the detection element is kept constant, so that errors in the detection output can be suppressed. In other words, the detection reliability can be improved.

The click ball 123 and the click groove 130a are coated with a lubricant (not illustrated) made of fluororesin, fluorooil, or the like to improve sliding properties. An edge portion 131 formed in a standing wall shape surrounding the click groove 130a is provided on the outer circumference side of the click groove 130a. The edge portion 131 is higher than the click groove 130a in the Y direction. This structure prevents the lubricant from moving due to the rotation of the dial 109 and spilling out of the click member 130. In addition, on the outside of the click member 130, the top cover member 111 includes a cone-shaped shielding portion 112 that surrounds the entire circumference of the click member 130. Thereby, the lubricant can be prevented from spilling out and dust can be prevented from entering the click groove 130a.

A standing wall portion 155 is provided near the detection element, where a part of the holding member 150 is formed into a standing wall shape. Thereby, light can be prevented from leaking from the detection element into the inside of the camera 100. In addition, light can be prevented from reaching the detection element from light-emitting components inside the camera 100. That is, the detection reliability can be improved. The standing wall portion 155 may be provided on the image sensor 302 side of the camera 100. Thereby, light from the detection element can be prevented from reaching the image sensor 302, and thereby noise can be prevented from occurring in the captured image.

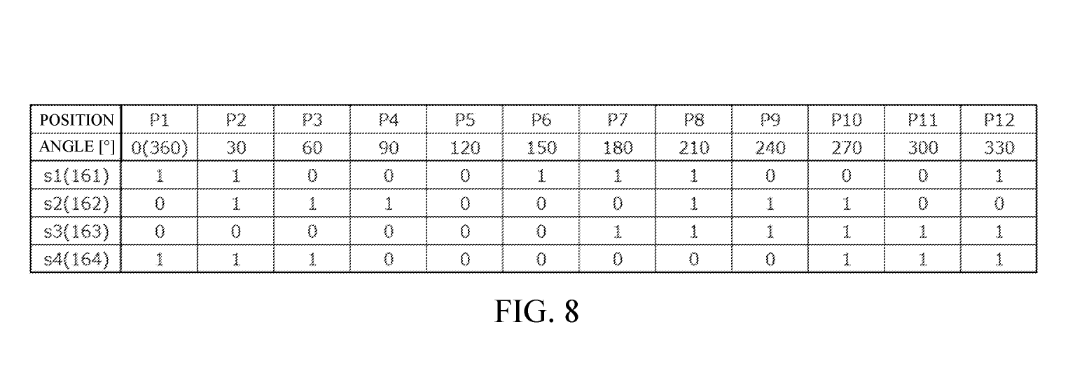

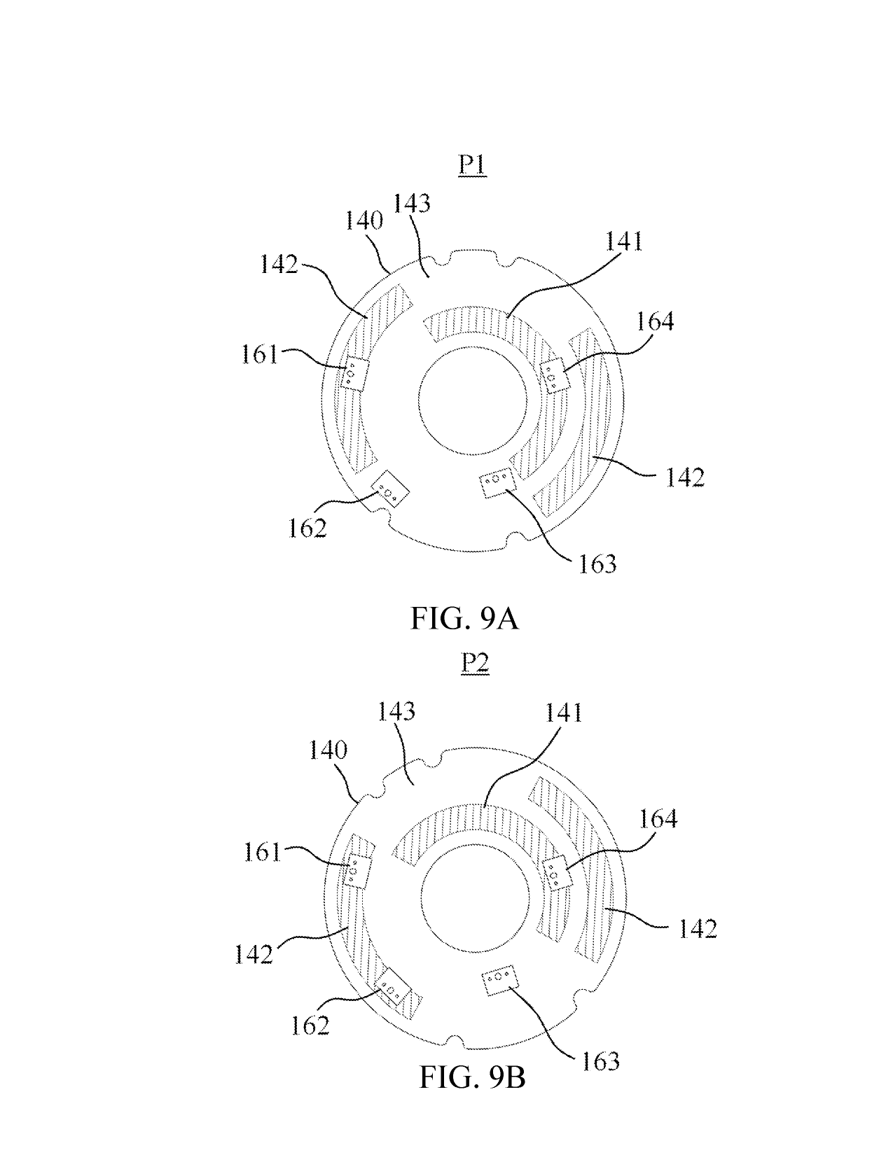

The phase detection operation will be described below with reference to FIGS. 8, 9A, and 9B. FIG. 8 illustrates a signal output when the phase of the dial 109 is located at each of twelve positions (positions P1-P12). FIGS. 9A and 9B illustrate a positional relationship between the phase plate 140 and the detection elements. FIGS. 9A and 9B illustrate positions P1 and P2, respectively.

In FIG. 9A, the first detection element 161 is located at a position opposite to the second reflective portion 142 and separated from it by a predetermined distance, so the system control unit 307 outputs the "High=1" signal. The second detection element 162 is located at a position opposite the non-reflective portion 143 and separated from it by a predetermined distance, so the system control unit 307 outputs the "Low=0" signal. The third detection element 163 is located at a position opposite to the non-reflective portion 143 and separated from it by a predetermined distance, so the system control unit 307 outputs the "Low=0" signal. Since the fourth detection element 164 is located at a position opposite to the first reflective portion 141 and separated from it by a predetermined distance, the system control unit 307 outputs the "High=1" signal. In other words, a combination of signals output from the system control unit 307 at position P1 is "1, 0, 0, 1."

FIG. 9B illustrates a state in which the phase plate 140 has rotated by 30° counterclockwise in conjunction with the rotation of the dial 109 from the state illustrated in FIG. 9A. In FIG. 9B, since the first detection element 161 is located at a position opposite to the second reflective portion 142 and separated from it by a predetermined distance, the system control unit 307 outputs the "High=1" signal. Since the second detection element 162 is located at a position opposite to the second reflective portion 142 and separated from it by a predetermined distance, the system control unit 307 outputs the "High=1" signal. Since the third detection element 163 is located at a position opposite to the non-reflective portion 143 and separated from it by a predetermined distance, the system control unit 307 outputs the "Low=0" signal. Since the fourth detection element 164 is located at a position opposite to the first reflective portion 141 and separated from it by a predetermined distance, the system control unit 307 outputs the "High=1" signal. In other words, a combination of signals output from the system control unit 307 at position P2 is "1, 1, 0, 1."

As described above, the positional relationship among the detection elements and the first reflective portion 141, the second reflective portion 142, and the non-reflective portion 143 changes due to the rotation of the dial 109. As illustrated in FIG. 8, the system control unit 307 can detect a rotation angle phase of the dial 109 based on the combination of signals output from the system control unit 307.

### SECOND EMBODIMENT

This embodiment will discuss a detection mechanism different from that of the first embodiment. The structure of the camera according to this embodiment is basically the same as that of the camera 100 according to the first embodiment. This embodiment will discuss only the structure different from that of the first embodiment, and will omit a description of the structure common to that of the first embodiment.

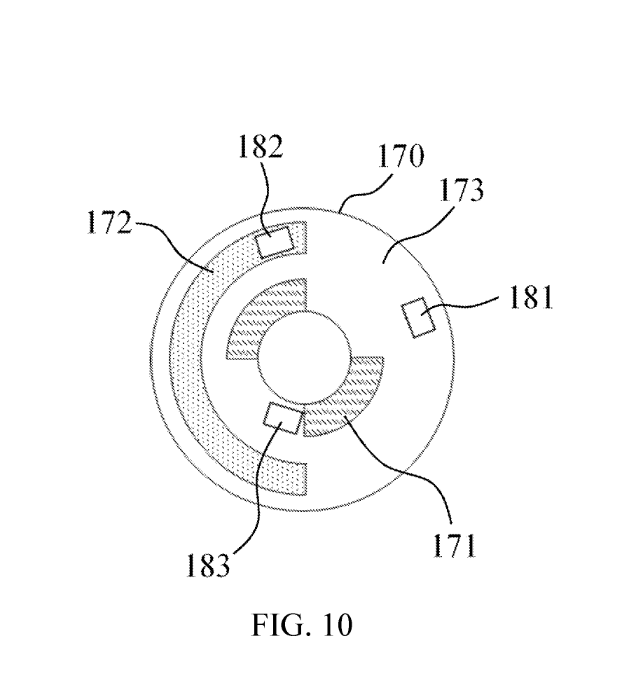

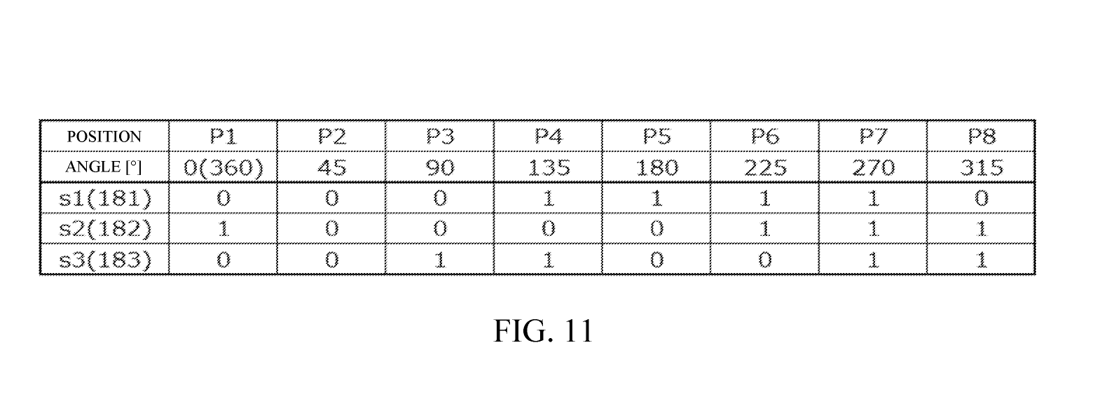

FIG. 10 illustrates a positional relationship between a phase plate 170 and detection elements (first detection element 181, second detection element 182, and third detection element 183) at position P1. FIG. 11 illustrates a signal output when the rotation angle phase of the dial 109 is located at each of eight positions.

The first detection element 181, second detection element 182, and third detection element 183 have the same structure as that of the first detection element 161 described in the first embodiment. The first reflective portion 171, second reflective portion 172, and non-reflective portion 173 of the phase plate 170 have the same structure as the first reflective portion 141, second reflective portion 142, and non-reflective portion 143 described in the first embodiment, respectively. In FIG. 10, the first detection element 181 is located at a position opposite to the non-reflective portion 173 and separated from it by a predetermined distance, so the system control unit 307 outputs the "Low=0" signal. The second detection element 182 is located at a position opposite to the second reflective portion 172 and separated from it by a predetermined distance, so the system control unit 307 outputs the "High=1" signal. The third detection element 183 is located at a position opposite to the non-reflective portion 173 and separated from it by a predetermined distance, so the system control unit 307 outputs the "Low=0" signal. In other words, a combination of signals output from the system control unit 307 at position P1 is "0,1,0." As illustrated in FIG. 11, when the phase plate 170 is rotated by every 45° counterclockwise from the state of position P1, it transitions to position P2, position P3, ..., position P8.

In this embodiment, two detection elements (first detection element 181 and second detection element 182) are disposed on the outer circumference side. Also, one detection element (third detection element 183) is disposed on the inner circumference side. That is, there are fewer detection elements on the inner circumference side than on the outer circumference side. Thereby, the diameter of the first reflective portion 171 can be reduced since there is no need to increase the distance between the detection elements compared to when plurality of detection elements are disposed on the inner circumference side. That is, the size of the camera 100 can be reduced.

### THIRD EMBODIMENT

This embodiment will discuss a click mechanism and a phase plate different from those of the first embodiment. The structure of the camera according to this embodiment is basically the same as that of the camera 100 according to the first embodiment. This embodiment will discuss only the structure different from that of the first embodiment, and will omit a description of the structure common to that of the first embodiment.

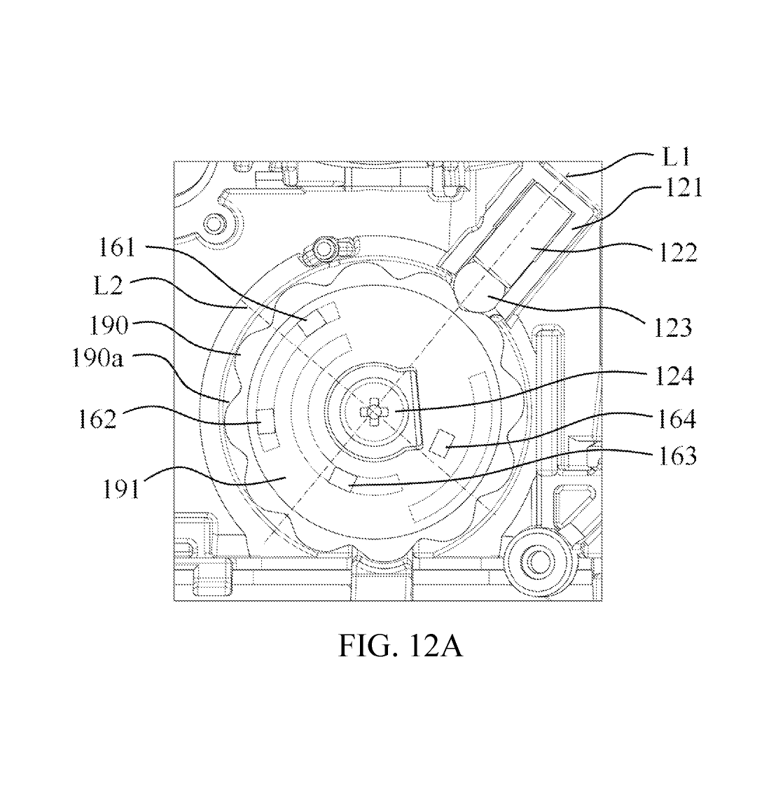

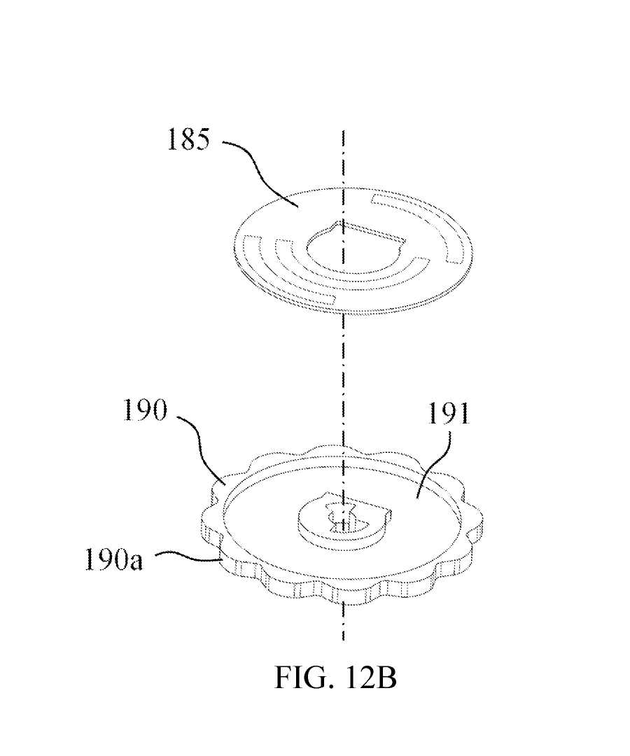

FIGS. 12A and 12B explain the click mechanism and phase plate of this embodiment. FIG. 12A illustrates the structures of the click member 190 and the detection mechanism. FIG. 12B illustrates the structures of the click member 190 and the phase plate 185. Those elements, which are corresponding elements in FIGS. 5A, 5B, 6, 7, 8, 9A, and 9B, will be designated by the same reference numerals.

Click grooves (groove portions) 190a are provided at predetermined angular intervals in the circumferential direction on the outer circumference of the click member 190. The click spring 122 and click ball 123 are stored in the storage portion 121. The click ball 123 is incorporated at a position corresponding to the unevenness of the click groove 190a, and the click spring 122 is incorporated in a compressed state. In this embodiment, the click spring 122 and click ball 123 are configured to generate a biasing force in a direction perpendicular to the shaft portion 109a of the dial 109. In other words, a click mechanism is configured in the radial direction. The phase plate 185 is formed of a sheet-like member made of resin or metal, and is attached to a concave portion 191, which has a reduced thickness of the click member 190, with double-sided tape (not illustrated) or the like. The first detection element 161, the second detection element 162, the third detection element 163, and the fourth detection element 164 are arranged at positions opposite to each of the ranges obtained by dividing the phase plate 185 into four equal parts when viewed from a direction parallel to the shaft portion 109a. More specifically, the range of the phase plate 185 is divided into four equal parts by a virtual line L1 passing through the shaft portion 109a (the center of the phase plate 185) and the centers of the click spring 122 and the click ball 123, and a virtual line L2 that is perpendicular to the virtual line L1 and passes through the center (rotation axis) of the phase plate 185. In that range, the first detection element 161 and the fourth detection element 164 are arranged at positions opposite to each other near the virtual line L2 (so as to face each other across the center of the phase plate 185 along the virtual line L2). That is, the first detection element 161 and the fourth detection element 164 are arranged at positions away from the click spring 122 and the click ball 123. Thereby, the click spring 122 and the click ball 123 can be prevented from erroneously reflecting light from the detection element. That is, the detection reliability can be improved.

The depth of the concave portion 191 is deeper than the thickness of the phase plate 185. Thereby, the concave portion 191 can function as a light shield, and can shielding external light rays. That is, the detection reliability can be improved.

### FOURTH EMBODIMENT

This embodiment will discuss a phase plate different from that according to the first embodiment. The structure of the camera according to this embodiment is basically the same as that of the camera 100 according to the first embodiment. This embodiment will discuss only the structure different from that according to the first embodiment, and will omit a description of the structure common to that of the first embodiment.

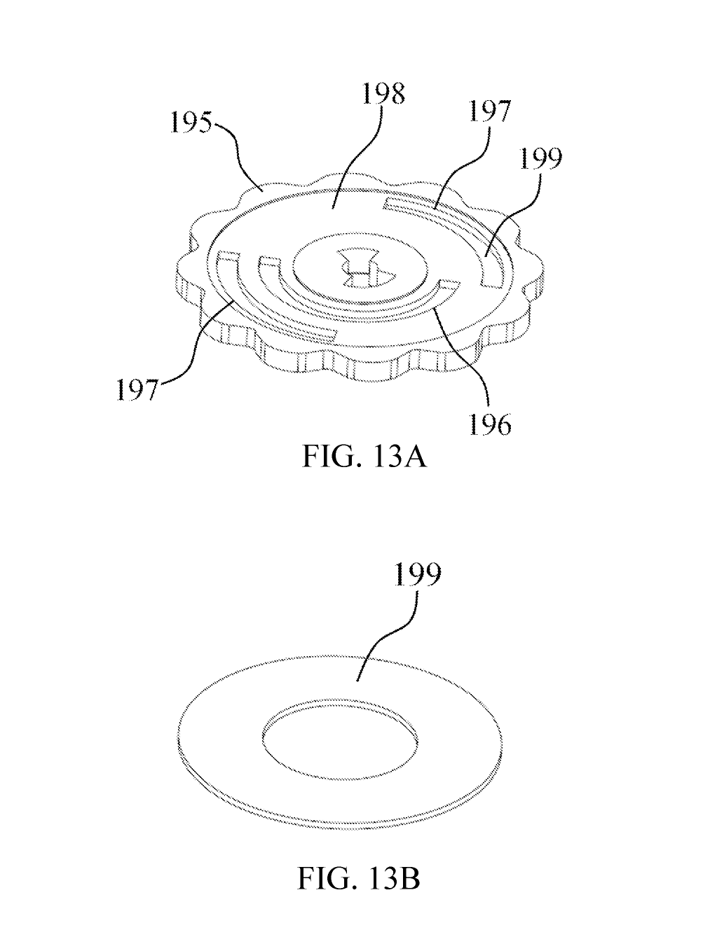

FIGS. 13A and 13B explain a phase plate 195 according to this embodiment. FIG. 13A illustrates the structure of the phase plate 195. FIG. 13B illustrates the structure of an insert metal plate 199.

The phase plate 195 is formed by insert molding using the insert metal plate 199, which is manufactured by pressing metal or the like, as an insert part.

The phase plate 195 has a first opening 196 and a second opening 197, which are circular sector-shaped with a predetermined central angle, on the inner and outer circumference sides. The insert metal plate 199 is exposed from the first opening 196 and the second opening 197. The surface of the insert metal plate 199 has a metallic luster. Thereby, the insert metal plate 199 exposed from the first opening 196 and the second opening 197 plays the same role as that of the first reflective portion 141 and the second reflective portion 142 in the first embodiment. The non-reflective portion 198 is surface-treated for suppressing reflection by embossing or the like on the resin surface.

As described above, the phase plate 195 is configured by insert molding with the insert metal plate 199 as an insert part. This structure eliminates the need to assemble a separate part, and improves assembly. Also, compared to a structure using separate parts, it is possible to reduce errors and improve positional accuracy with respect to the detection element. In other words, the detection reliability can be improved. In addition, it is possible to accommodate changes in the number of detection positions and the positional relationship with the detection elements by changing the shapes of the first opening 196 and the second opening 197. In this case, it is not necessary to change the shape of the insert metal plate 199, and parts can be standardized.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment according to the disclosure can provide a detection mechanism that can detect a rotational position with high reliability.

This application claims the benefit of Patent Application No. 2024-173110, which was filed on October 2, 2024, and which is hereby incorporated by reference herein in its entirety.

What is claimed is:

1. A detection mechanism comprising:
a rotational operation member rotatable around a rotation axis;
a phase plate that includes a plurality of reflective portions disposed on a plurality of concentric circles around the rotation axis and configured to reflect light, and a non-reflective portion configured to reflect less light than each of the plurality of reflective portions, and is rotatable together with the rotational operation member;
a plurality of detection elements arranged on the plurality of concentric circles facing either one of the plurality of reflective portions or the non-reflective portion, and configured to output a signal according to an intensity of light reflected by either one of the plurality of reflective portions or the non-reflective portion;
one or more memories storing instructions; and
one or more processors that, upon execution of the instructions, operate to determine a rotation position of the rotational operation member according to an output of each of the plurality of detection elements,
wherein the plurality of detection elements are arranged on different straight lines that pass through the rotation axis and extend in a radial direction perpendicular to the rotation axis.

2. The detection mechanism according to claim 1, wherein when viewed from a direction parallel to the rotation axis, the plurality of detection elements are arranged so as to overlap different ranges among a plurality of ranges obtained by equally dividing the phase plate by the number of the plurality of detection elements using virtual lines intersecting at the rotation axis.

3. The detection mechanism according to claim 1, wherein the plurality of reflective portions include a first reflective portion provided on a first concentric circle and a second reflective portion provided on a second concentric circle having a diameter longer than that of the first concentric circle, and
wherein at least a part of the non-reflective portion is provided between the first reflective portion and the second reflective portion in the radial direction.

4. The detection mechanism according to claim 3, wherein the plurality of detection elements include, in order along a rotation direction of the rotational operation member, a first detection element, a second detection element, a third detection element, and a fourth detection element,
wherein the first detection element and the second detection element are arranged on the second concentric circle, and
wherein the third detection element and fourth detection element are arranged on the first concentric circle.

5. The detection mechanism according to claim 4, wherein a distance between the first detection element and the second detection element, a distance between the third detection element and fourth detection element, and a distance between the second detection element and the third detection element are equal.

6. The detection mechanism according to claim 4, wherein the number of the first reflective portions is one, and the number of the second reflective portions is two.

7. The detection mechanism according to claim 3, wherein the plurality of detection elements includes, in order along a rotation direction of the rotational operation member, a first detection element, a second detection element, and a third detection element,
wherein the first detection element and the second detection element are disposed on the second concentric circle, and
wherein the third detection element is disposed on the first concentric circle.

8. The detection mechanism according to claim 7, wherein the number of the first reflective portions is two, and the number of the second reflective portions is one.

9. The detection mechanism according to claim 1, wherein the plurality of detection elements include a detection element disposed on a first concentric circle and a detection element disposed on a second concentric circle having a diameter longer than that of the first concentric circle,
wherein each of the detection element disposed on the first concentric circle and the detection element disposed on the second concentric circle includes a first light emitter and a second light emitter, each of which emits the light,
wherein the first light emitter is disposed on a side opposite to a rotation axis side of the detection element disposed on the first concentric circle in the radial direction, and
wherein the second light emitter is disposed on the rotation axis side of the detection element disposed on the second concentric circle in the radial direction.

10. The detection mechanism according to claim 1, wherein the plurality of reflective portions are surface-treated differently from each other.

11. The detection mechanism according to claim 1, wherein the plurality of detection elements include a detection element disposed on a first concentric circle and a detection element disposed on a second concentric circle having a diameter larger than that of the first concentric circle, and
wherein the detection element disposed on the first concentric circle and the detection element disposed on the second concentric circle output different signals when receiving light of a same intensity.

12. The detection mechanism according to claim 1, further comprising a click mechanism that includes a click member having a groove formed along a direction parallel to the rotation axis, and generates a click sense when a spherical member is engaged with the groove,
wherein the click member has an edge portion having a standing wall shape surrounding the groove on an outer circumference of the click member.

13. The detection mechanism according to claim 1, further comprising a click mechanism that includes a click member having a groove formed along a direction perpendicular to the rotation axis, a spherical member engageable with the groove, and a biasing member biasing the spherical member toward the groove,
wherein in a range divided by a first virtual line passing through the rotation axis, a center of the spherical member, and the biasing member, and a second virtual line orthogonal to the first virtual line and passing through the rotation axis, two of the plurality of detection elements are arranged to face each other along the second virtual line across the rotation axis.

14. The detection mechanism according to claim 1, wherein the plurality of reflective portions are treated to reflect the light, and
wherein the non-reflective portion is treated to suppress reflection of the light.

15. An image pickup apparatus comprising:
a detection mechanism; and
an image sensor,
wherein the detection mechanism includes:
a rotational operation member rotatable around a rotation axis,
a phase plate that includes a plurality of reflective portions disposed on a plurality of concentric circles around the rotation axis and configured to reflect light, and a non-reflective portion configured to reflect less light than each of the plurality of reflective portions, and is rotatable together with the rotational operation member,
a plurality of detection elements arranged on the plurality of concentric circles facing either one of the plurality of reflective portions or the non-reflective portion, and configured to output a signal according to an intensity of light reflected by either one of the plurality of reflective portions or the non-reflective portion,
one or more memories storing instructions, and
one or more processors that, upon execution of the instructions, operate to determine a rotation position of the rotational operation member according to an output of each of the plurality of detection elements,
wherein the plurality of detection elements are arranged on different straight lines that pass through the rotation axis and extend in a radial direction perpendicular to the rotation axis.
